(19) United States
(12) Patent Application Publication
(10) Pub. No.: US 2016/0313612 A1
(43) Pub. Date: Oct. 27, 2016

(54) LIQUID CRYSTAL LENS AND DISPLAY DEVICE

(71) Applicant: BOE TECHNOLOGY GROUP CO., LTD., Beijing (CN)

(72) Inventors: Naifu WU, Beijing (CN); Kun WU, Beijing (CN); Xiaolin WANG, Beijing (CN); Yunyun TIAN, Beijing (CN); Bo WANG, Beijing (CN)

(21) Appl. No.: 14/784,293

(22) PCT Filed: Apr. 17, 2015
(86) PCT No.: PCT/CN2015/076850

§ 371 Date: Oct. 14, 2015

(30) Foreign Application Priority Data
Nov. 12, 2014 (CN) 201410645970.7

(51) Int. Cl. G02F 1/1343; G02B 27/22; G02F 1/29

(52) U.S. Cl. CPC G02F 1/134309; G02F 1/13439; G02F 1/29; G02B 27/225; G02F 2001/133357

(57) ABSTRACT

The present invention provides a liquid crystal lens and a display device, belongs to the field of display technology, and can solve a problem that strong lateral electric fields formed between strip electrodes of an existing liquid crystal lens influence the imaging effect. The liquid crystal lens of the present invention comprises: a first substrate, a second substrate and a liquid crystal layer provided therebetween; a plurality of layers of strip electrodes are provided on a surface, facing the second substrate, of the first substrate, and counter electrodes arranged at least opposite to the strip electrodes are provided on a surface, facing the first substrate, of the second substrate; wherein any two strip electrodes adjacent in a horizontal direction are arranged in different layers, the strip electrodes in different layers are insulated from each other and there is no overlap between their projections on the first substrate.

### FIELD OF THE INVENTION

The present invention belongs to the field of display technology, and specifically relates to a liquid crystal lens and a display device.

### BACKGROUND OF THE INVENTION

With the continuous development of the display technology, three-dimensional (3D) display has become an important development tendency in the field of display. The basic principle of the 3D display is to make different images seen by the left eye and the right eye of a person and then subjected to visual processing by the brain so that the images which the person sees become stereoscopic.

At present, the 3D display is classified into two major categories, i.e., glasses-free 3D display and glasses 3D display. The glasses-free 3D display is to process images on a display panel to generate stereoscopic images, so that users can experience the 3D display with naked eyes rather than by means of 3D glasses.

The liquid crystal lens is a way of realizing the glasses-free 3D display, and the liquid crystal lens is generally provided on the display panel. As shown in FIG. 1, an existing liquid crystal lens consists of a first substrate 101, a second substrate 201 and a liquid crystal layer arranged between the two substrates. Strip electrodes 102 are arranged on the first substrate 101, and a plate electrode 202 is arranged on the second substrate 201. By using an electric field formed between the strip electrodes 102 and the plate electrode 202 to drive the in-between liquid crystal layer, the liquid crystal layer forms several lenses to refract images displayed on the display panel towards a left eye visual area and a right eye visual area respectively, so that stereoscopic images are formed.

However, in a liquid crystal lens in the prior art, a strong lateral electric field will be formed between two adjacent strip electrodes, resulting in poor display.

Specifically, as shown in FIG. 1, in order to realize the 3D display, different voltages will be applied to the strip electrodes 102 arranged on the first substrate 101. Therefore, a certain voltage difference may exist between two adjacent strip electrodes 102. As the distance between the strip electrodes 102 is small, a strong lateral electric field will be formed between two adjacent strip electrodes 102, and the influence of the lateral electric field on liquid crystal molecules in the liquid crystal layer will cause the liquid crystal lens to generate a dissatisfactory phase delay. FIG. 2 is an experiment result diagram illustrating a phase delay curve generated by an existing liquid crystal lens. As shown in FIG. 2, there are glitches on the phase delay curve at a position corresponding to the lateral electric field (see a position circled in FIG. 2). As a result, a problem of poor imaging effect of the liquid crystal lens is caused.

### SUMMARY OF THE INVENTION

In view of the aforementioned problem in an existing liquid crystal lens, the present invention provides a liquid crystal lens and a display device capable of effectively improving the imaging effect.

A technical solution employed to solve the aforementioned technical problem is a liquid crystal lens, including: a first substrate, a second substrate and a liquid crystal layer arranged between the first substrate and the second substrate; a plurality of layers of strip electrodes are provided on a surface, facing the second substrate, of the first substrate, and counter electrodes arranged at least opposite to the strip electrodes are provided on a surface, facing the first substrate, of the second substrate; wherein,

any two strip electrodes adjacent in a horizontal direction are arranged in different layers, the strip electrodes in different layers are insulated from each other and there is no overlap between their projections on the first substrate.

In a case where the number of the strip electrodes on the first substrate of the liquid crystal lens of the present invention is the same as that of the strip electrodes arranged on the first substrate of the existing liquid crystal lens, as the strip electrodes of the embodiment are alternately arranged in different layers at intervals, the distance between two adjacent strip electrodes in a height direction (longitudinal direction) is increased. According to a field strength formula: E=U/d, an increased distance in the height direction indicates an increased value of d in this formula, consequently, the intensity of a lateral electric field formed between two adjacent strip electrodes is decreased, thus eliminating or alleviating the problem of a dissatisfactory phase delay curve of the liquid crystal lens resulting from the influence of the strong lateral electric field formed between the two adjacent strip electrodes on liquid crystal molecules in the liquid crystal layer in the prior art; and furthermore, the imaging effect of the electric control liquid crystal lens is improved.

Preferably, the counter electrodes may be a plate electrode.

Preferably, two layers of strip electrodes are arranged on the surface, facing the second substrate, of the first substrate, the first layer of strip electrodes include a plurality of first strip electrodes, the second layer of strip electrodes include a plurality of second strip electrodes, and the first strip electrodes and the second strip electrodes are alternately arranged in the horizontal direction at intervals.

Preferably, voltages applied to the strip electrodes on the first substrate are 0 V during 2D image display.

Preferably, the first substrate provided with the strip electrodes is divided into a plurality of units, each of which includes n adjacent strip electrodes, where n is an integer greater than or equal to 2; and

voltages applied to the strip electrodes in each of the units are different during 3D image display.

Further preferably, there are 6 strip electrodes included in each of the units.

Preferably, a planarization layer is arranged between two adjacent layers of strip electrodes on the first substrate.

Further preferably, thickness of the planarization layer ranges from 2 μm to 5 μm.

Preferably, a plurality of protrusive structures are arranged on the first substrate, and the second strip electrodes are arranged on the protrusive structures.

A technical solution employed to solve the aforementioned technical problem is a display device, including the aforementioned liquid crystal lens.

As the display device of the present invention includes the aforementioned liquid crystal lens, the display device of the present invention can effectively avoid poor display resulting from the strong lateral electric field formed between two adjacent strip electrodes.

### BRIEF DESCRIPTION OF THE DRAWINGS

FIG. 1 is a schematic diagram of an existing liquid crystal lens;

FIG. 2 is a simulation result diagram of the existing liquid crystal lens;

FIG. 3 is a schematic diagram of a liquid crystal lens according to Embodiment 1 of the present invention; and

FIG. 4 is a simulation result diagram of the liquid crystal lens according to Embodiment 1 of the present invention;

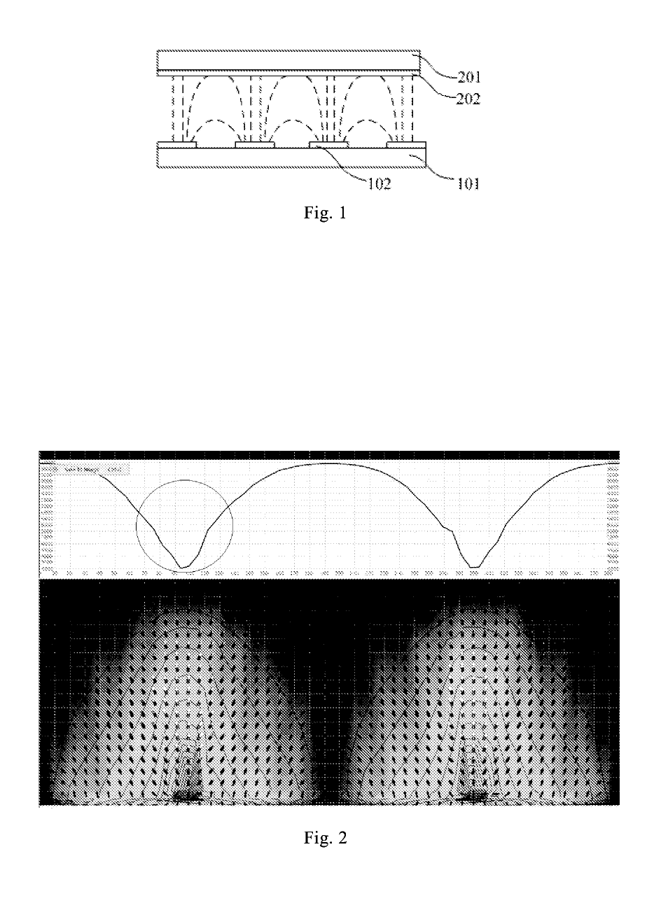

### REFERENCE NUMERALS

101: first substrate;
102: strip electrode;
1021: first strip electrode;
1022: second strip electrode;
103: planarization layer;
201: second substrate; and
202: plate electrode.

### DESCRIPTION OF THE PREFERRED EMBODIMENT

In order to make those skilled in the art understand the technical solutions of the present invention better, the present invention will be further described below in detail with reference to the accompanying drawings and specific implementations.

### Embodiment 1

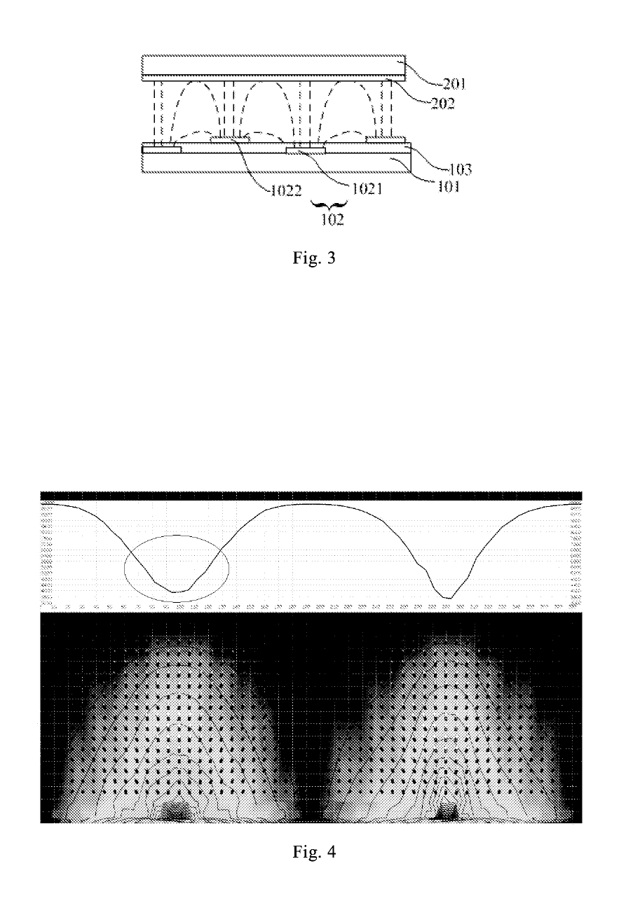

As shown in FIG. 3 and FIG. 4, this embodiment provides a liquid crystal lens, including a first substrate 101, a second substrate 201 and a liquid crystal layer arranged between the first substrate 101 and the second substrate 201. A plurality of layers of strip electrodes 102 are arranged on a surface, facing the second substrate 201, of the first substrate 101, and counter electrodes arranged at least opposite to the strip electrodes are arranged on a surface, facing the first substrate 101, of the second substrate 201. Any two strip electrodes adjacent in a horizontal direction are arranged in different layers. The strip electrodes 102 in different layers are insulated from each other and there is no overlap between their projections on the first substrate 101. A certain voltage difference exists between voltages applied to the counter electrode and the strip electrodes 102 so as to form an electric field to drive the liquid crystal molecules to deflect, thus forming a plurality of liquid crystal lenses.

In a case where the number of the strip electrodes 102 on the first substrate 101 of the liquid crystal lens in this embodiment is the same as that of the strip electrodes 102 arranged on the first substrate 101 of an existing liquid crystal lens, as any two strip electrodes adjacent in a horizontal direction are arranged in different layers at intervals in the present embodiment, the distance between two adjacent strip electrodes in a height direction (longitudinal direction) is increased. According to a field strength formula: E=U/d, an increased distance in the height direction indicates an increased value of d in this formula, consequently, the intensity of the lateral electric field formed between two adjacent strip electrodes 102 is decreased, thus eliminating or alleviating the problem in the prior art that, a strong lateral electric field generated between two adjacent strip electrodes 102 influences the liquid crystal molecules in the liquid crystal layer and thus the phase delay curve of the liquid crystal lens is dissatisfactory, and imaging effect of the liquid crystal lens is poor.

The phase delay curve generated by the liquid crystal lens of the present embodiment is shown in FIG. 4. Compared with the phase delay curve generated by the existing liquid crystal lens shown in FIG. 2, the phase delay curve shown in FIG. 4 is obviously gentle (as a position circled in FIG. 4), thereby improving the imaging effect of the liquid crystal lens.

As each counter electrode on the second substrate 201 is generally applied with same voltage during image display, preferably, the counter electrodes may be a plate electrode 202. Of course, the counter electrodes may also be slit electrodes, as long as there are counter electrodes arranged at positions, corresponding to the strip electrodes 102 on the first substrate 101, on the second substrate 201. In this case, the slit widths of slit electrodes on the second substrate 201 may be adjusted so that the deflecting direction of the liquid crystal molecules at positions corresponding to the slits is substantially the same as that of the liquid crystal molecules at position s corresponding to the electrodes.

In order to simplify the structure of the liquid crystal lens, preferably, two layers of strip electrodes are arranged on a surface, facing the second substrate 201, of the first substrate 101. As shown in FIG. 3, a first layer of strip electrodes include a plurality of first strip electrodes 1021, and the second layer of strip electrodes include a plurality of second strip electrodes 1022. The first strip electrodes 1021 and the second strip electrodes 1022 are arranged alternately in a horizontal direction at intervals. In this way, a horizontal electric field formed between a first strip electrode 1021 and a second strip electrode 1022 which are adjacent to each other is decreased, thus improving the imaging effect of the liquid crystal lens. Of course, three layers, four layers or more layers of strip electrodes 102 may be arranged on a surface, facing the second substrate 201, of the first substrate 101, as long as it is ensured that there is no overlap between projections of the strip electrodes 102 on the first substrate 101.

2D image display and 3D image display may be realized by arranging the liquid crystal lens of the present embodiment on a light-exiting surface of an existing display panel.

Preferably, voltages applied to the two layers of strip electrodes 102 arranged on the first substrate 101 are 0 V during 2D image display, that is, there is no voltage applied to the strip electrodes 102. Thereby, 2D images are displayed by the existing display panel.

Preferably, the first substrate 101 including a plurality of strip electrodes 102 is divided into a plurality of regions (units), so that each unit includes n adjacent strip electrodes 102, where n is an integer greater than or equal to 2. Different voltages are applied to the strip electrodes 102 in each unit during 3D image display, so that the deflection of the liquid crystal molecules can be controlled through voltages applied to the two layers of strip electrodes 102. In this way, the left eye and the right eye of a user can see two images at different positions, i.e. a left eye image and a right eye image. Thereby, the user feels that a 3D image is formed in front of his/her eyes. Voltages applied to any two adjacent strip electrodes 102 in the two layers of strip electrodes 102 are different, that is to say, a voltage difference exists; however, as there is a height difference between the two layers of strip electrodes 102, according to the field strength formula: E=U/d, the distance in the height direction (i.e. the value of d) is increased, and consequently, the intensity of the lateral electric field formed between two adjacent strip electrodes 102 is decreased, which eliminates or alleviates the problem in the prior art that, as a strong lateral electric field generated between two adjacent strip electrodes 102 influences the liquid crystal molecules in the liquid crystal layer, glitches occur in the phase delay curve of the liquid crystal lens, thus resulting in poor imaging effect of the liquid crystal lens. Further preferably, there are 6 strip electrodes 102 included in each unit. Of course the number of the strip electrodes 102 included in each unit is not limited to 6, and may be set according to specific situations.

Preferably, a planarization layer 103 is arranged between two adjacent layers of strip electrodes 102, so that a certain height difference exists between two adjacent layers of strip electrodes 102, and two adjacent layers of strip electrodes 102 are insulated from each other. Specifically, as shown in FIG. 3, the planarization layer is arranged between the first layer of strip electrodes and the second layer of strip electrodes. Further preferably, the thickness of the planarization layer 103 ranges from 2 μm to 5 μm. The height difference between the two adjacent layers of strip electrodes 102 is realized by the thickness of the planarization layer 103, and thus the height difference between two adjacent strip electrodes 102 is increased so as to decrease a lateral electric field between two adjacent strip electrodes 102. Still further preferably, the thickness of the planarization layer is 2 μm, and in this case, the display device will be lighter and thinner. The thickness of the planarization layer is not limited thereto, and may be set according to specific situations. As an alternative to the planarization layer, in order to create a certain height difference between two adjacent layers of strip electrodes 102, in other preferred embodiments, a plurality of protrusive structures may be arranged on the first substrate 101, and the second strip electrodes 1022 are arranged on the protrusive structures, thus decreasing the lateral electric field between a first strip electrode 1021 and a second strip electrode 1022 which are adjacent to each other.

It should be noted that the adjacent strip electrodes 102 in the present embodiment refer to two adjacent strip electrodes 102 in two adjacent layers rather than two adjacent strip electrodes 102 arranged in the same layer.

### Embodiment 2

This embodiment provides a display device, including the liquid crystal lens in Embodiment 1. The display device may be any product or component having a display function, such as a mobile phone, a tablet, a TV set, a display, a laptop, a digital photo frame, a navigator, etc.

As the display device of the present embodiment includes the liquid crystal lens in Embodiment 1, the display device of the present embodiment can effectively avoid poor display resulting from a strong lateral electric field formed between two adjacent strip electrodes 102.

The display device of the present embodiment is preferably a 3D display device, which can also realize 2D display. Specifically, 3D display or 2D display may be realized by changing voltages applied to the strip electrodes 102. Specific implementations of 3D display and 2D display are the same as those of the prior art, and will not be described in detail here.

Of course, the display device of the present embodiment may further include other conventional structures such as a display drive unit, etc.

It should be understood that the aforementioned implementations are merely exemplary implementations for describing the principle of the present invention, and the present invention is not limited thereto. For a person of ordinary skill in the art, various variations and improvements may be made without departing from the spirit and essence of the present invention, and those variations and improvements should be regarded as falling into the protection scope of the present invention.

1-10. (canceled)

11. A liquid crystal lens, comprising: a first substrate, a second substrate and a liquid crystal layer provided between the first substrate and the second substrate, wherein a plurality of layers of strip electrodes are provided on a surface, facing the second substrate, of the first substrate, and counter electrodes arranged at least opposite to the strip electrodes are provided on a surface, facing the first substrate, of the second substrate; and wherein,
any two strip electrodes adjacent in a horizontal direction are arranged in different layers, the strip electrodes in different layers are insulated from each other, and there is no overlap between projections of the strip electrodes in different layers on the first substrate.

12. The liquid crystal lens according to claim 11, wherein the counter electrodes are a plate electrode.

13. The liquid crystal lens according to claim 11, wherein two layers of strip electrodes are arranged on the surface, facing the second substrate, of the first substrate; the first layer of strip electrodes comprise a plurality of first strip electrodes, and the second layer of strip electrodes comprise a plurality of second strip electrodes; and the first strip electrodes and the second strip electrodes are alternately arranged in the horizontal direction at intervals.

14. The liquid crystal lens according to claim 11, wherein voltages applied to the strip electrodes on the first substrate are 0 V during 2D image display.

15. The liquid crystal lens according to claim 11, wherein the first substrate provided with the strip electrodes is divided into a plurality of units, each of which comprises n adjacent strip electrodes, where n is an integer greater than or equal to 2; and
voltages applied to the strip electrodes in each of the units are different during 3D image display.

16. The liquid crystal lens according to claim 15, wherein there are 6 strip electrodes included in each of the units.

17. The liquid crystal lens according to claim 11, wherein a planarization layer is provided between two adjacent layers of strip electrodes on the first substrate.

18. The liquid crystal lens according to claim 17, wherein thickness of the planarization layer ranges from 2 μm to 5 μm.

19. The liquid crystal lens according to claim 13, wherein a plurality of protrusive structures are provided on the first substrate, and the second strip electrodes are arranged on the protrusive structures.

20. A display device, comprising the liquid crystal lens according to claim 11.

21. The display device according to claim 20, wherein the counter electrodes are a plate electrode.

22. The display device according to claim 20, wherein two layers of strip electrodes are arranged on the surface, facing the second substrate, of the first substrate; the first layer of strip electrodes comprise a plurality of first strip electrodes, and the second layer of strip electrodes comprise a plurality of second strip electrodes; and the first strip electrodes and the second strip electrodes are alternately arranged in the horizontal direction at intervals.

23. The display device according to claim 20, wherein voltages applied to the strip electrodes on the first substrate are 0 V during 2D image display.

24. The display device according to claim 20, wherein the first substrate provided with the strip electrodes is divided into a plurality of units, each of which comprises n adjacent strip electrodes, where n is an integer greater than or equal to 2; and
voltages applied to the strip electrodes in each of the units are different during 3D image display.

25. The display device according to claim 24, wherein there are 6 strip electrodes included in each of the units.

26. The display device according to claim 20, wherein a planarization layer is provided between two adjacent layers of strip electrodes on the first substrate.

27. The display device according to claim 26, wherein thickness of the planarization layer ranges from 2 μm to 5 μm.

28. The display device according to claim 22, wherein a plurality of protrusive structures are provided on the first substrate, and the second strip electrodes are arranged on the protrusive structures.

29. The display device according to claim 21, wherein a planarization layer is provided between two adjacent layers of strip electrodes on the first substrate.

30. The display device according to claim 22, wherein a planarization layer is provided between two adjacent layers of strip electrodes on the first substrate.
